(19) United States
(12) Patent Application Publication
(10) Pub. No.: US 2017/0263140 A1
(43) Pub. Date: Sep. 14, 2017

(54) Devices And Methods For A Writing Instrument With Spelling Assistance

(71) Applicant: Andre Maurice Adams, JR., Bowling Green, KY (US)

(72) Inventor: Andre Maurice Adams, JR., Bowling Green, KY (US)

(21) Appl. No.: 15/451,507

(22) Filed: Mar. 7, 2017

Related U.S. Application Data
(60) Provisional application No. 62/305,505, filed on Mar. 8, 2016.

(51) Int. Cl. G09B 5/04; B43K 29/00; G09B 17/00

(52) U.S. Cl. CPC G09B 5/04; G09B 17/006; B43K 29/00

(57) ABSTRACT

Devices and methods for a writing instrument with spelling assistance are disclosed herein. The device assists the user with looking up, verifying, and correcting the spelling of words while writing. In an embodiment, the device is comprised of a housing element, a writing element, a computing element, and operating elements. The housing element provides the body of the device that holds the other elements together. In embodiments, the housing element is configured at the distal end with an opening for allowing the writing element to dispense on a surface the writing material. In other embodiments, the housing element is configured at the distal end with a writing point to apply pressure on another surface for receiving words written. The computing element is positioned within the housing element and is configured with computing items to store and run software to provide the looking up, verifying, and correcting the spelling of words functionality.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to devices and methods for writing instruments. More specifically, the present invention relates to devices and methods for a writing instrument, which assists the user of the device with looking up, verifying, and correcting the spelling of words.

### BACKGROUND OF THE INVENTION

Without limiting the scope of the disclosed device and method, the background is described in connection with devices and methods for writing instruments with spelling assistance.

Individuals today when utilizing a pen, pencil, or other writing instrument often encounters a word they are unsure of its spelling. At times, the individual or user of existing writing instruments in the art may spell a word incorrectly and not even be aware of the error. Today, an individual has to reference another resource such as a dictionary to look up and verify the spelling of the word. This can be time consuming and such resource may not even be readily available.

In view of the foregoing, it is apparent that there exists a need in the art for a writing instrument, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for devices and methods directed to writing instruments with spelling assistance. A user of the device, while writing or not, may obtain instant spelling feedback. As they write, the device will notify the user if a word is misspelled or the user of the device can input via typing or saying into the device a word to receive the correct spelling of the word.

In an embodiment, the device is comprised of a housing element, a writing element, a computing element, and at least one operating element.

In embodiments, the housing element provides the body of the device that holds the other elements together. In embodiments, the housing element is configured at the distal end with an opening for allowing the writing element to dispense on a surface the writing material. In other embodiments, the housing element is configured at the distal end with a writing point to apply pressure on another surface for receiving inputs.

The computing element is positioned within the housing element and is configured with computing items to store and run software to provide the looking up, verifying, and spelling correction of words functionality.

The writing element in embodiments may be comprised of materials used to write on another surface such as lead and ink. The writing element is configured to hold the materials component if needed and is positioned substantially within the housing element.

The operating element in embodiments, are user controls configured on the housing element that allow the user of the device to operate the device and interact with the computing element. The operating element may be comprised of but not limited to buttons, switches, microphones, speakers, GUIs, displays, and screens.

In summary, the present invention discloses devices and methods for writing instruments. More specifically, the present invention relates to devices and methods for a writing instrument, which assists the user of the device with looking up, verifying, and correcting the spelling of words.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is a top view of the writing instrument with spelling assistance device in accordance with the teachings of the present disclosure;

FIG. 2 is a side view of the writing instrument with spelling assistance device in accordance with the teachings of the present disclosure;

FIG. 3 is a side view of the cap of the writing instrument with spelling assistance device in accordance with the teachings of the present disclosure;

FIG. 4 is a perspective view of the writing instrument with spelling assistance device in accordance with the teachings of the present disclosure;

FIG. 5 is a side view of the writing instrument with spelling assistance device also comprising a touch screen display screen combination and input element in accordance with the teachings of the present disclosure;

FIG. 6 is a top view of the writing instrument with spelling assistance device also comprising a touch screen display screen combination and input element in accordance with the teachings of the present disclosure;

FIG. 7 is a perspective view of the writing instrument with spelling assistance device also comprising a touch screen display screen combination and input element in accordance with the teachings of the present disclosure;

FIG. 8 is a side view of the writing instrument with spelling assistance device also comprising a touch screen, display screen, and input element alternative configuration in accordance with the teachings of the present disclosure;

FIG. 9 is a top view of the writing instrument with spelling assistance device also comprising a touch screen, display screen, and input element alternative configuration in accordance with the teachings of the present disclosure;

FIG. 10 is a perspective view of the writing instrument with spelling assistance device also comprising a touch screen, display screen, and input element alternative configuration in accordance with the teachings of the present disclosure;

### DETAILED DESCRIPTION OF THE INVENTION

Disclosed herein are devices and methods directed to writing instruments with spelling assistance. The numerous innovative teachings of the present invention will be described with particular reference to several embodiments (by way of example, and not of limitation).

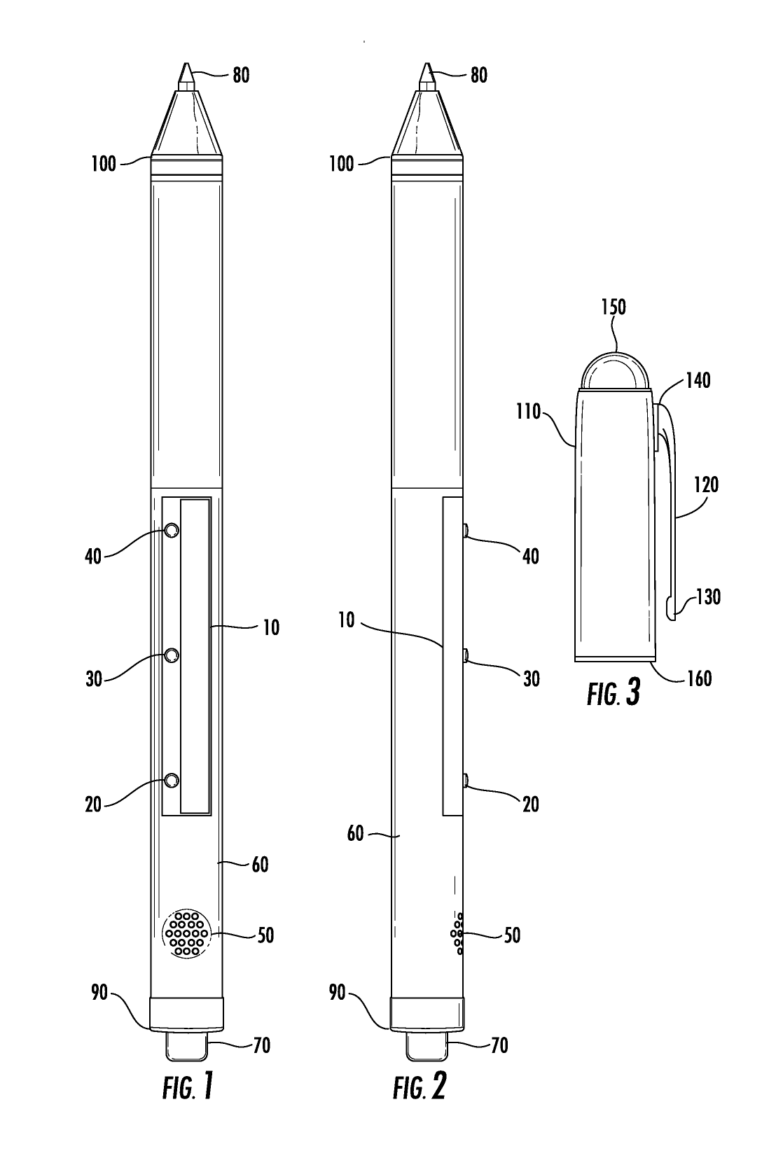

Reference is first made to FIG. 1, a top view of the writing instrument with spelling assistance device in accordance with the teachings of the present disclosure. Illustrated in this figure is the writing instrument with spelling assistance device showing the main elements. In an embodiment, the device is comprised of a housing element 60, a writing element 80, a computing element (positioned internally in the housing element), and at least one operating element 10, 20, 30, 40, 50, 70.

In embodiments, the housing element 60 provides the body of the device that holds the other elements together. In embodiments, the housing element 60 is configured at the distal end with an opening for allowing the writing element to dispense on a surface the writing material. In other embodiments, the housing element 60 is configured at the distal end with a writing point 80 to apply pressure on another surface for receiving inputs. In embodiments the housing element is configured in the shape of a cylindrical tube. In embodiments, the housing element 60 is made from rigid materials such as but not limited to metals, woods, and polymers.

The computing element is positioned within the housing element 60 and is configured as a computer or computing device to provide the looking up, verifying, and spelling correction of words functionality. The computing element 60 in embodiments is a computer or computing device configured to perform the steps discussed herein to provide the looking up, verifying, and spelling correction of words functionality. The computing device being comprised of a storage device, memory, processor, and power source (such as a battery). The storage device is any non-transitory computer-readable storage medium, such as a hard drive, compact disk read-only memory (CD-ROM), DVD, or a solid-state memory device. The memory holds instructions and data used by the processor. As is known in the art, a computer can have different and/or other components than those described above. In addition, the computer can lack certain components described above. As is known in the art, the computer is adapted to execute computer program modules for providing functionality described herein. In one embodiment, program modules are stored on the storage device, loaded into the memory, and executed by the processor.

The writing element 80 in embodiments may be comprised of materials used to write on another surface such as lead and ink. The writing element 80 is configured to hold the materials component if needed and is positioned substantially within the housing element.

The operating element 10, 20, 30, 40, 50, 70 in embodiments, are user controls configured on the housing element 60 that allow the user of the device to operate the device and interact with the computing element. The operating element 10, 20, 30, 40, 50, 70 may be comprised of but not limited to buttons, switches, microphones, speakers, GUIs, displays, and screens. Also illustrated in this figure are the operating element buttons 20, 30, 40 as well as the display screen 10 and the writing position button 70. The operating element buttons 20, 30, 40 in embodiments are a power button, a clear word button, and a speaker/microphone button. The power button turns the device on and off. The clear word button clears the word being displayed on the screen 10 or will clear what is displayed on the screen 10. The speaker/microphone button activates the speaker/microphone 50 for, in an embodiment, receiving a word spoken by the user of the device to return the correct spelling of the received word by displaying the word on the screen 10. The writing position button 70 puts the device in a first writing position or a second non-writing position.

In embodiments, the device is configured with software for spell checking what the user of the device is writing. If a misspelled word is detected, an alert such as but not limited to an audible, visual, or physical alert is provided to the user. The alert may be, as an example and not a limitation, an audible alarm through the speaker/microphone 50 or the display screen 10 lighting up. In embodiments, the display screen 10 will display the misspelled word detected.

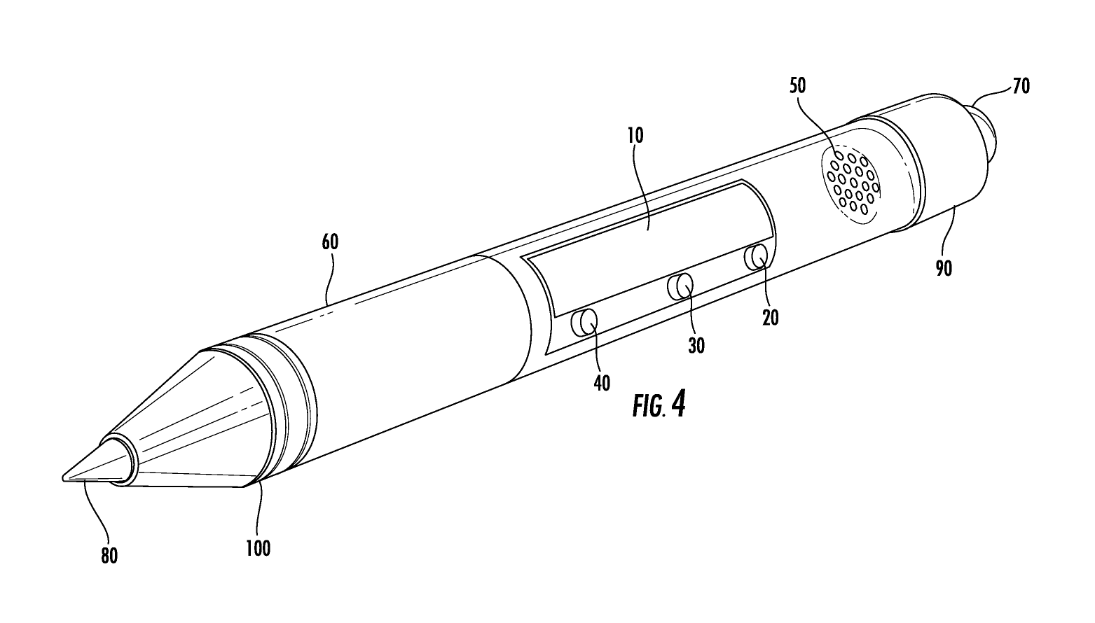

Reference is next made to FIG. 2, a side view of the writing instrument with spelling assistance device in accordance with the teachings of the present disclosure. Illustrated in this figure is the device from the side showing the operating elements 10, 20, 30, 40, 50, 70 previously discussed from the distal end 100 to the proximal end 90.

Reference is now made to FIG. 3, a side view of the cap of the writing instrument with spelling assistance device in accordance with the teachings of the present disclosure. Illustrated in this figure is, in embodiments, a device cap 110 being comprised of a cap body 110, a cap top portion 150, a cap open end 160, and a cap clip 120. In embodiments, the device cap clip 120 is comprised of a cap clip clipping end 130 and a detachable end 140, which allows the device cap 110 to be separated from the cap body 110 and used as a stylus.

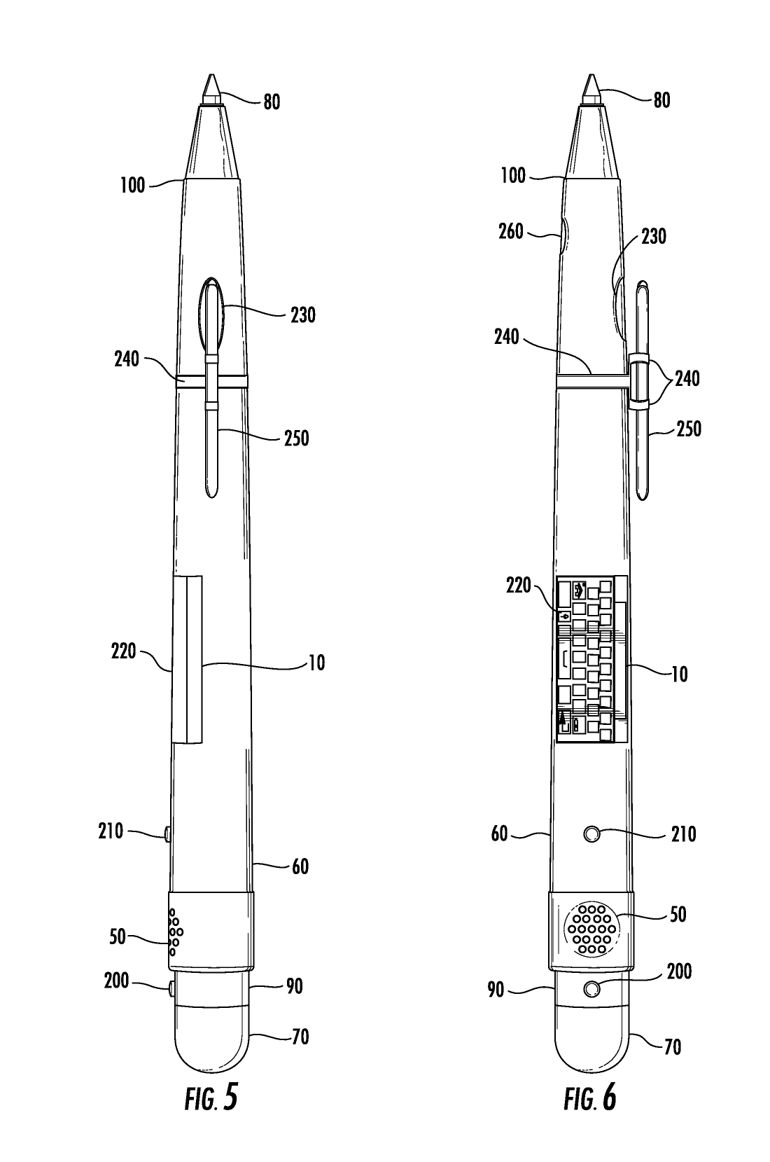

Reference is next made to FIG. 4, a perspective view of the writing instrument with spelling assistance device in accordance with the teachings of the present disclosure. Illustrated in this figure is the device from a more frontal view.

Reference is now made to FIG. 5, a side view of the writing instrument with spelling assistance device also comprising a touch screen display screen 10 combination and input element in accordance with the teachings of the present disclosure. Illustrated in this figure is the device in an embodiment also being comprised of an input element 250. In an embodiment, the input element 250 is a releasably attachable stylus 250 with a stylus holder 240 attached to the housing element 60. Also illustrated in an embodiment is the device also being comprised of a touch screen 220 and display screen 10 combination. The user can use the touch screen 220 of the display screen 10 to input commands and words to be spell checked. The input element 250 may be used to type or key on the touch screen 200. Also shown is the stylus indention 230 which is an ergonomic feature making it easier to detach the input element 250 from the housing element 60. Also shown in this figure are the operating elements 200, 210 position at different locations on the housing element. That is operating elements 20, 30, 40 have been repositioned.

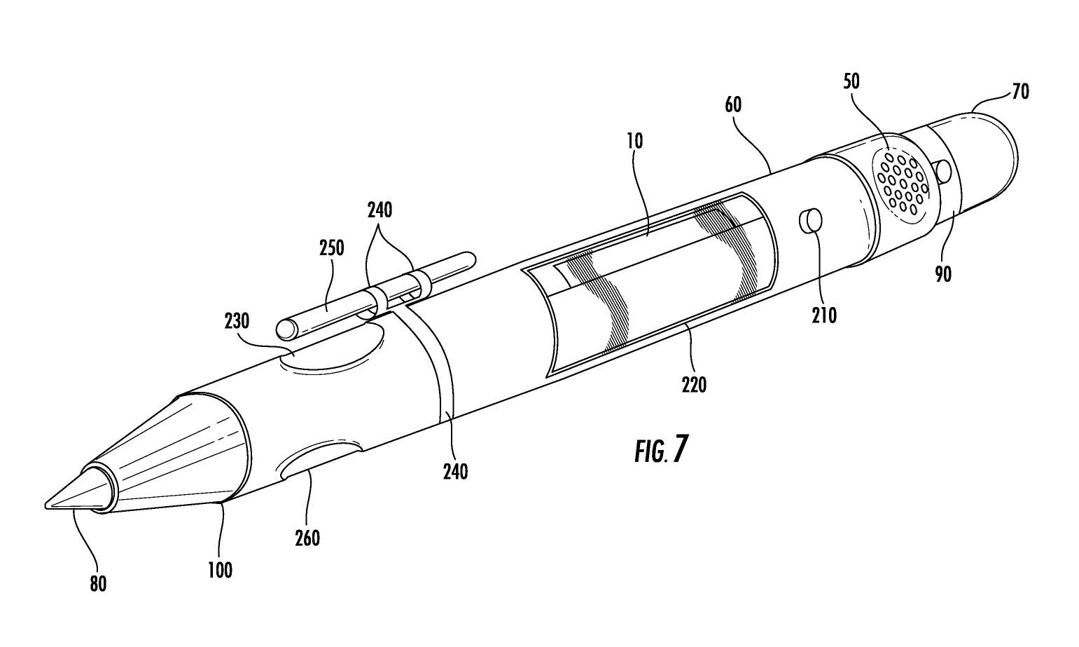

Reference is next made to FIG. 6, a top view of the writing instrument with spelling assistance device also comprising a touch screen display screen combination and input element in accordance with the teachings of the present disclosure. Illustrated in this figure is the device from the side showing the operating elements 10, 50, 70, 210, 220 previously discussed from the distal end 100 to the proximal end 90.

Reference is now made to FIG. 7, a perspective view of the writing instrument with spelling assistance device also comprising a touch screen display screen combination and input element in accordance with the teachings of the present disclosure. Illustrated in this figure is the device from a more frontal view showing the repositioning of the operating elements 20, 30, 40 as well as the touch screen 220 display screen 10 combination and input element 250. The input element release button 260 is also shown.

Reference is next made to FIG. 8, a side view of the writing instrument with spelling assistance device also comprising a touch screen, display screen, and input element alternative configuration in accordance with the teachings of the present disclosure. Illustrated in this figure is an embodiment where the touch screen 220 and display screen 10 are positioned apart on the housing element 60 of the device. What is being illustrated in this figure is how the operating elements 10, 20, 30, 40, 50, 70, 200, 210 as well as the touch screen 220 and display screen 10 are not constrained by any positioning on the housing element.

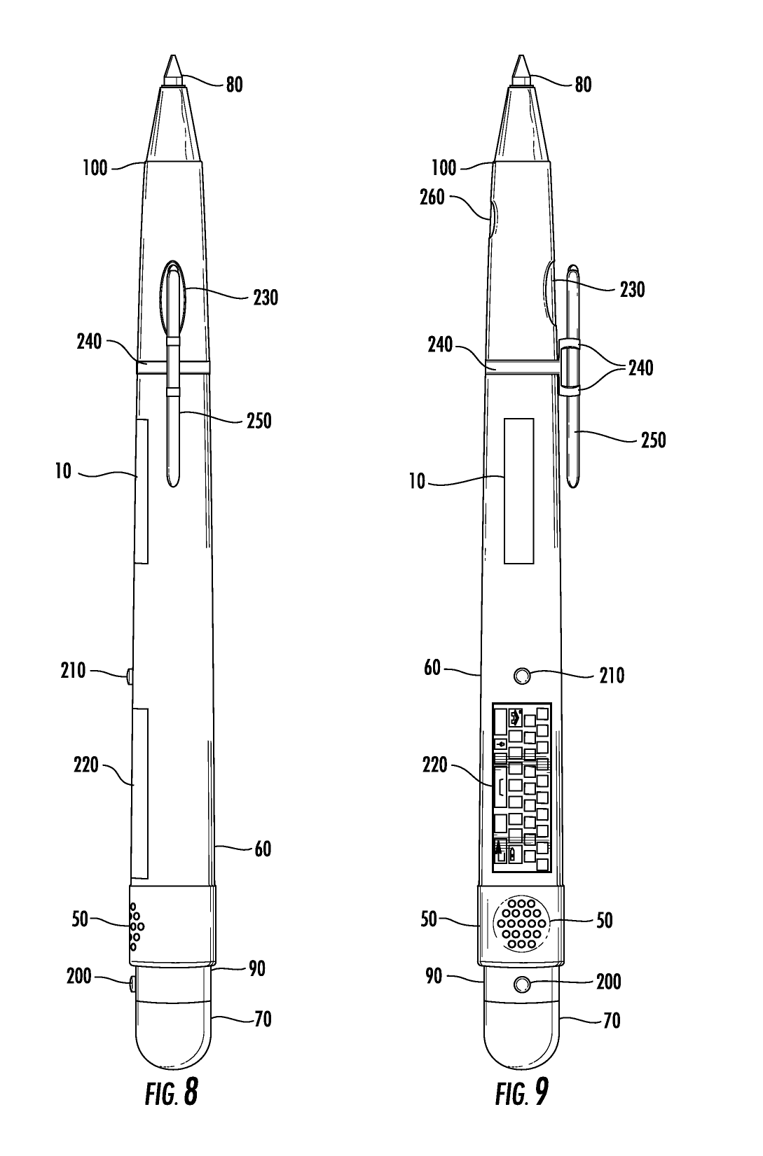

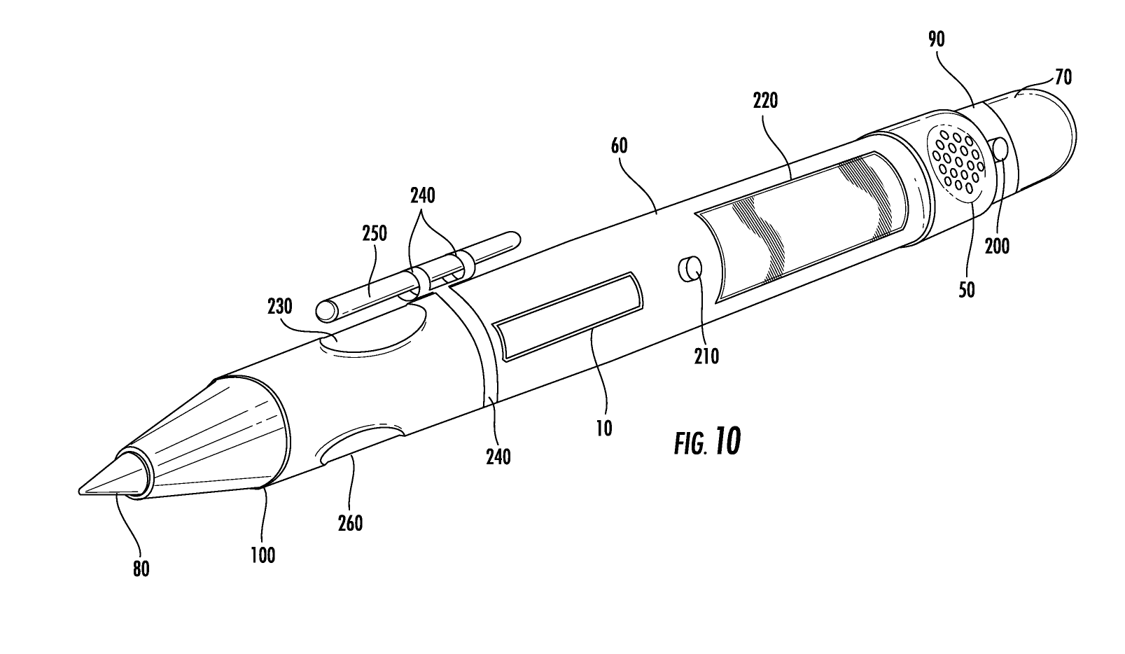

Reference is now made to FIG. 9, a top view of the writing instrument with spelling assistance device also comprising a touch screen, display screen, and input element alternative configuration in accordance with the teachings of the present disclosure. Illustrated in this figure is the device from the side showing the operating elements 10, 50, 70, 210, 220 and the repositioning of the touch screen 220 and display screen 10 previously discussed, from the distal end 100 to the proximal end 90.

Reference is lastly made to FIG. 10, a perspective view of the writing instrument with spelling assistance device also comprising a touch screen, display screen, and input element alternative configuration in accordance with the teachings of the present disclosure. Illustrated in this figure is the device from a more frontal view showing the repositioning of the touch screen 220 display screen 10.

The disclosed devices and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific devices and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The devices and/or methods disclosed and claimed herein can be made and executed without undue experimentation in light of the present disclosure. While the device and methods of this invention have been described in terms of preferred embodiments, it will be apparent to those skilled in the art that variations may be applied to the devices and/or methods and in the steps or in the sequence of steps of the methods described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A device for a writing instrument with spelling assistance as disclosed herein.

2. A method for a writing instrument with spelling assistance as disclosed herein.
